(19) United States
(12) Patent Application Publication
(10) Pub. No.: US 2004/0126659 A1
(43) Pub. Date: Jul. 1, 2004

(54) High-capacity nanostructured silicon and lithium alloys thereof

(76) Inventors: Jason A. Graetz, Upton, NY (US); Brent T. Fultz, Pasadena, CA (US); Channing Ahn, Pasadena, CA (US); Rachid Yazami, Los Angeles, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/660,382

(22) Filed: Sep. 10, 2003

Related U.S. Application Data
(60) Provisional application No. 60/409,516, filed on Sep. 10, 2002.

(51) Int. Cl. H01M 4/40; H01M 4/58

(52) U.S. Cl. 429/218.1; 429/231.95

(57) ABSTRACT

Electrodes comprising lithium alloyed with nanostructured silicon materials exhibit improved capacities, cycle lives, and/or cycling rates compared with similar electrodes made from bulk silicon. The electrodes do not require a conductive diluent such as carbon black. These electrodes are useful as anodes for secondary electrochemical cells, for example, batteries and electrochemical supercapacitors.

### RELATED APPLICATIONS

The present application claims the benefit of U.S. Provisional Application No. 60/409,516, filed Sep. 10, 2002, the disclosure of which is incorporated by reference in its entirety.

### STATEMENT REGARDING FEDERALLY SPONSORED RESEARCH OR DEVELOPMENT

Some aspects of the disclosed invention were made with the support of the Department of Energy of the U.S. Government under Basic Energy Sciences Grant No. DE-FG03-00ER15035. The U.S. Government may have certain rights in the invention.

### BACKGROUND OF THE INVENTION

1. Field of the Invention

The present application relates generally to the fabrication of secondary electrochemical cells, and more particularly, of nanostructured lithium-silicon alloys useful as electrodes.

2. Description of the Related Art

Batteries are used to power electrical devices that are not easily powered by a fixed source of power, for example, portable electronics and spacecraft. Certain applications, for example, electric vehicles, are limited by the energy capacities of available rechargeable batteries, which are also referred to as secondary electrochemical cells. Among the commercially available secondary electrochemical cells with the highest energy capacities are lithium ion batteries, which use graphite-based anodes.

A method of increasing the energy density in the cell is to increase the density of lithium in the anode, for example, by using a metallic lithium anode. Metallic lithium presents safety issues, however, which restrict metallic lithium anodes in secondary batteries to small, rechargeable cells. When lithium cell is recharged, lithium is electroplated onto the anode. In a cell with a metallic lithium anode, it is difficult to prevent the growth of lithium dendrites on the anode on charging. Dendritic growth of lithium between the anode and cathode creates a short circuit within the battery, rendering the battery unusable.

An electrode comprising a framework material into which the lithium atoms can reversibly enter and exit can control the electrode geometry or shape, and consequently, prevent dendritic growth of lithium. A framework material reduces the specific or gravimetric capacity of the electrode, however. Accordingly, an ideal framework material would have both low density and high lithium capacity. Ideally, the framework material would require little or no binders or additives that would further reduce the capacity of the electrode.

Commercially available lithium-ion batteries often use graphitic anodes, in which lithium atoms intercalate between the graphite layers. The theoretical maximum stoichiometry of a graphitic anode is LiC₆, which translates into a specific capacity of about 372 mAh/g. In certain cases, solvent cointercalation in the graphite anodes reduces the storage capacity from the theoretical value.

An attractive anode material is silicon. Electrochemically synthesized lithium-silicon alloys (LiₓSi) with stoichiometries of x=1.71, 2.33, 3.25, and 4.40 are stable, crystalline materials. The specific capacity of Li_{4.4}Si (Li₂₂Si₅) is 4200 mAh/g. Consequently, silicon has a high theoretical gravimetric capacity.

Fully lithiating the silicon results in a 300% volume increase in the electrode, however. The concomitant mechanical stresses pulverize the material within a few charge/discharge cycles, which reduces the electrical integrity of the electrode and between the electrode and the current collector. Bulk silicon anodes lose all capacity after a few charge/discharge cycles.

### SUMMARY OF THE INVENTION

Disclosed are nanostructured silicon materials and nanostructured alkali metal-silicon alloys. The alloys in one embodiment are produced by electrochemically alloying an alkali metal, for example lithium, with a nanostructured silicon material. Electrodes fabricated from the nanostructured silicon materials reversibly alloy with and release lithium on charging and discharging, respectively. Embodiments of these electrodes exhibit improvements in any one of or some combination of charge capacity, cycle life, or cycling rate. The disclosed electrodes are useful as anodes in secondary electrochemical cells.

Accordingly, an embodiment of the present invention provides a silicon nanofilm and lithium alloys thereof, and electrodes made from the same. In one embodiment, the silicon nanofilm alloys with lithium at ambient temperature. In one embodiment, the silicon nanofilm is not greater than about 100 nm thick. In another embodiment, in the theoretical stoichiometry LiₓSi, x is at least about 2.1. In certain embodiments, the silicon nanofilm is substantially amorphous. Preferably, the silicon nanofilm is synthesized by physical vapor deposition.

Another embodiment provides a silicon nanoparticle and lithium alloys thereof, wherein the diameter of the silicon nanoparticle is not greater than about 50 nm in diameter, and electrodes made from the same. In one embodiment, the silicon nanoparticle alloys with lithium at ambient temperature. In another embodiment, in the theoretical stoichiometry LiₓSi, x is at least about 1.05. In one embodiment, the silicon nanoparticle has a crystalline domain. Preferably, the silicon nanoparticle is synthesized by inert gas condensation and ballistic consolidation.

Still another embodiment provides an electrode comprising nanostructured silicon or a lithium alloy thereof, wherein the electrode substantially does not comprise carbon black. In one embodiment, the silicon nanofilm alloys with lithium at ambient temperature. Embodiments of the disclosed electrode provide improved electrochemical performance without using conductive diluents such as carbon black, thereby increasing the gravimetric capacity of the electrode. Preferably, the lithium alloy has a specific capacity of at least 1000 mAh/g, more preferably, at least 2000 mAh/g. In one embodiment, the lithium alloy has a cycle life of at least about 20. In another embodiment, the specific capacity of the lithium alloy at 100C is at least about ⅔ of the specific capacity at C/4. In certain embodiments, the nanostructured silicon is a silicon nanoparticle or a silicon nanofilm.

Another embodiment of the disclosed invention provides a method of synthesizing a silicon nanoparticle and a silicon nanoparticle synthesized by a method comprising at least the step of evaporating elemental silicon into a gas, thereby forming a silicon nanocrystal, wherein the gas comprises hydrogen. In one embodiment, the method further comprises accelerating the gas and entrained nanocrystal, and depositing the nanocrystal on a substrate. In one embodiment, the gas comprises nitrogen.

Another embodiment provides a secondary electrochemical cells, which is a battery or an electrochemical supercapacitor, which comprise an anode, a cathode, and an electrolyte, wherein the anode comprises a silicon nanofilm or a lithium alloy thereof. In one embodiment, the silicon nanofilm alloys with lithium at ambient temperature. In another embodiment, the lithium alloy has a theoretical stoichiometry of LiₓSi, and x is at least about 2.1. In another embodiment, the silicon nanofilm is not greater than about 100 nm thick. In another embodiment, the silicon nanofilm is substantially amorphous. In another embodiment, the silicon nanofilm is synthesized by physical vapor deposition. In another embodiment, the secondary electrochemical cell is a battery or an electrochemical supercapacitor.

Yet another embodiment provides a secondary electrochemical cell comprising an anode, a cathode, and an electrolyte, wherein the anode comprises a silicon nanoparticle or a lithium alloy thereof, and the diameter of the silicon nanoparticle is not greater than about 50 nm in diameter. In one embodiment, the silicon nanoparticle alloys with lithium at ambient temperature. In another embodiment, the lithium alloy has a theoretical stoichiometry of LiₓSi, and x is at least about 1.05. In another embodiment, the silicon nanoparticle has a crystalline domain. In another embodiment, the silicon nanoparticle is synthesized by inert gas condensation and ballistic consolidation. In another embodiment, the secondary electrochemical cell is a battery or an electrochemical supercapacitor.

Still another embodiment provides a secondary electrochemical cell comprising an anode, a cathode, and an electrolyte, wherein the anode comprises nanostructured silicon or a lithium alloy thereof, and the anode does not comprise carbon black. In one embodiment, the nanostructured silicon alloys with lithium at ambient temperature. In another embodiment, the nanostructured silicon has a specific capacity of at least 1000 mAh/g or at least 2000 mAh/g. In another embodiment, the nanostructured silicon has a cycle life of at least about 20. In another embodiment, the specific capacity of the nanostructured silicon at 100C is at least about ⅔ of the specific capacity at C/4. In another embodiment, the nanostructured silicon comprises a silicon nanoparticle. In another embodiment, the nanostructured silicon comprises a silicon nanofilm. In another embodiment, the secondary electrochemical cell is a battery or an electrochemical supercapacitor.

### BRIEF DESCRIPTION OF THE DRAWINGS

FIG. 1 is a schematic of the gas-phase ballistic consolidation chamber used to synthesize silicon nanocrystals.

FIG. 2 illustrates an embodiment of a method for synthesizing silicon nanocrystals.

FIG. 3 is an X-ray diffractogram of the nanocrystalline silicon on a glass substrate.

FIGS. 4a and b are bright-field and dark-field TEM images of silicon nanocrystals, respectively. The dark-field image was created with the (220) and (311) diffraction rings. FIG. 4c is another bright-field image with an electron diffraction pattern inset. FIG. 4d is an HREM image of the nanocrystalline silicon showing a crystallite with an encapsulating amorphous layer.

FIG. 5a illustrates silicon L_{2,3}-edges from silicon and SiO₂ standards, the averaged spectrum from silicon and SiO₂, and the nanocrystalline silicon, as deposited. FIG. 5b illustrates the oxygen K-edge of ballistically deposited silicon nanocrystals confirming the presence of oxygen.

FIGS. 6a and b are, respectively, bright-field plan-view and cross-sectional TEM images from the evaporated amorphous silicon revealing the uniform, contiguous nature of the as-deposited 100 nm film.

FIG. 7 provides SEM images of (a) nickel coated fiberglass substrate, (b) nanocrystalline silicon on fibrous nickel substrate, and (c) nanocrystalline silicon after the first electrochemical alloying with lithium (discharged).

FIGS. 8a and b are, respectively, the voltage profile and differential capacity, d|x|/dE for cycles 1, 15, and 30 from ballistically deposited silicon on a fibrous substrate. FIGS. 8c and d are, respectively, the voltage profile and differential capacity for cycles 1, 25, and 50 from ballistically deposited silicon on a planar copper substrate. FIGS. 8e and f are, respectively, the voltage profile and differential capacity for cycles 1, 25, and 50 from evaporated silicon. The arrows indicate the charge step of the first cycle. Δx corresponds to a change in lithium concentration of LiₓSi.

FIG. 9 illustrates the gravimetric capacity of ballistically deposited silicon on a fibrous substrate, planar substrate, and evaporated silicon on a planar substrate. Light and shaded markers indicate charge and discharge steps, respectively.

FIG. 10 illustrates the coulombic efficiency of ballistically deposited silicon on fibrous and planar substrates, and evaporated silicon on a planar substrate.

FIG. 11a illustrates the gravimetric capacity of an evaporated silicon nanofilm electrode at variable cycling rates (log scale). Light and shaded markers indicate charge and discharge steps, respectively. (◯) First round of cycles up to about 200C. (⋄) Second round of cycles (same electrode) up to about 500C. FIG. 11b illustrates the gravimetric capacity of evaporated silicon thin film at an initial rate of C/4 and a high rate of about 100C exhibiting a stable cycle life.

FIG. 12 provides spectra of the lithium K-edge and silicon L_{2,3}-edge of fully lithiated silicon (discharged). The inset shows background subtracted silicon L_{2,3}-edge.

FIGS. 13a and b are, respectively, bright-field TEM image and electron diffraction pattern of silicon electrode after the first discharge (fully lithiated).

### DETAILED DESCRIPTION OF THE PREFERRED EMBODIMENTS

References to the electrochemical properties of the disclosed nanostructured silicon materials include the properties of the nanostructured silicon as well as the lithium-silicon alloys produced from the nanostructured silicon. The term “battery” is used in its ordinary meaning, as well as to refer to both an individual cell as well as a battery. The term “secondary electrochemical cell” is used in its normal meaning, and also to mean “battery” and “electrochemical supercapacitor.” An electrochemical supercapacitor is an electrical storage device comprising electrodes and an electrolyte, which is capable of very fast charge and discharge rates. Charges are typically stored in a “double layer” at the electrode/electrolyte interface. Electrochemical supercapacitor electrodes typically use high active-surface-area materials, for example, carbons and metal oxides.

Disclosed herein are nanostructured silicon materials and alkali metal alloys thereof that are useful as anodes in secondary electrochemical cells. Secondary electrochemical cells typically comprise an anode, a cathode, and an electrolyte. In certain embodiments, the secondary electrochemical cells are useful as batteries or as electrochemical supercapacitors.

Certain embodiments of the nanostructured silicon electrodes demonstrate improved charge/discharge cycle life compared with bulk silicon electrodes in lithium electrochemical cells. On charging, the nanostructured silicon materials electrochemically alloy with lithium from the electrolyte to form lithium-silicon (Li—Si) alloys. This process is also referred to as “lithiation.” On discharging, the lithium-silicon alloy releases lithium into the electrolyte. In certain embodiments, the lithiation and/or reverse reaction occurs at ambient temperature. The nanostructured silicon materials may also be used in electrochemical cells of other alkali metals, for example, sodium, potassium, rubidium, and cesium. Accordingly, also disclosed are electrochemically synthesized alloys of alkali metals with the disclosed nanostructured silicon materials, and in particular, lithium-silicon alloys.

In one embodiment, the nanostructured silicon material is substantially pure silicon. In another embodiment, the silicon is doped. Any known dopant compatible with the conditions in the secondary electrochemical cell may be used. Examples of suitable dopants include boron, arsenic, antimony, and phosphorus. As used herein, the term “silicon” includes substantially pure silicon and doped silicon, as well as silicon that includes impurities, for example, silicon dioxide, unless otherwise stated.

In certain embodiments, the nanostructured silicon is crystalline. In other embodiments, the nanostructured silicon is amorphous. In still other embodiments, the nanostructured silicon has both crystalline and amorphous domains.

In one embodiment, the nanostructured silicon is in the form of particles, also referred to herein as “nanoparticles.” In certain embodiments, the diameter of a particle is not greater than about 300 nm, 290 nm, 280 nm, 270 nm, 260 nm, 250 nm, 240 nm, 230 nm, 220 nm, 210 nm, 200 nm, 190 nm, 180 nm, 170 nm, 160 nm, 150 nm, 140 nm, 130 nm, 120 nm, 110 nm, 100 nm, 90 nm, 80 nm, 70 nm, 60 nm, 50 nm, 40 nm, 30 nm, 20 nm, 10 nm, 5 nm, 2 nm, or 1 nm. In certain preferred embodiments, the particle is not greater than about 50 nm, not greater than about 20 nm, or not greater than about 10 nm. The nanoparticles are present as individual particles, clusters of particles, or a combination thereof. The silicon nanoparticles are synthesized by any means known in the art, for example, by grinding or milling, by solution synthesis, by physical vapor deposition, or by chemical vapor deposition. In one embodiment, the particles are synthesized by “inert gas condensation and ballistic consolidation,” which is also referred to herein as “ballistic consolidation,” and which is described in greater detail below. In embodiments in which the nanoparticles are crystalline or partially crystalline, the particles are also referred to as “nanocrystals.”

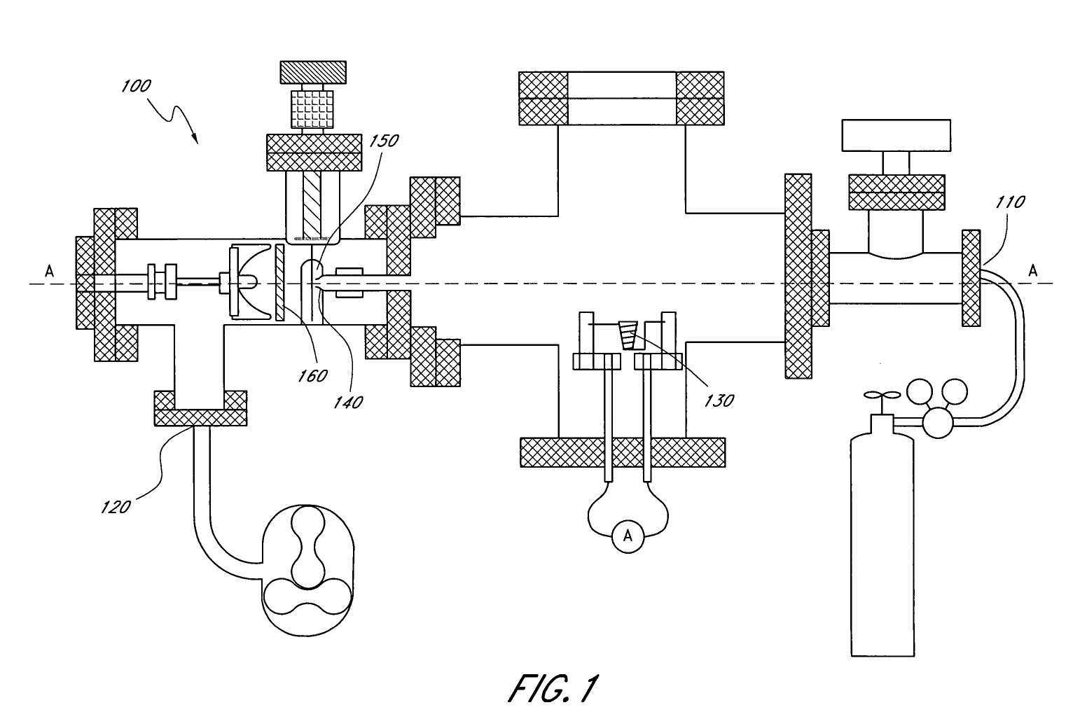

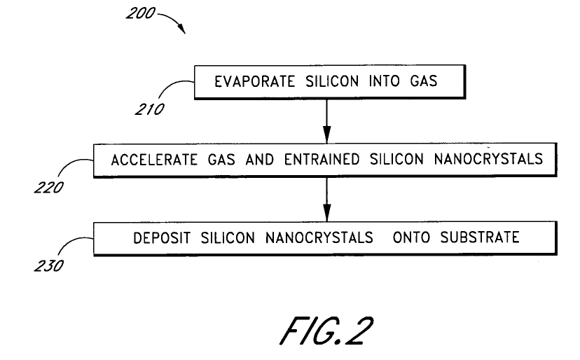

In one embodiment, nanocrystalline silicon clusters are produced by inert gas condensation and ballistic consolidation in a deposition chamber 100 illustrated in FIG. 1. The apparatus is constructed from materials known in the art that are compatible with the processing conditions, for example, stainless steel, quartz, fluorocarbon elastomers, and the like. The illustrated device comprises a gas inlet port 110 and a gas outlet port 120 disposed at opposite ends of the elongate deposition chamber 100. Together, the inlet port 110 and outlet port 120 create a pressure differential along axis A-A. The inlet port 110 is fluidly connected to a gas source. The outlet port 120 is in fluid connection with a vacuum source. Preferably, the vacuum source is a high vacuum source, for example, capable of evacuating the deposition chamber 100 to about 100 mtorr. In one embodiment, the pressure differential is controllable, for example, by controlling the gas source and/or vacuum source using means known in the art. In a preferred embodiment, the vacuum source has a capacity sufficient to accommodate any desired gas flow, and the pressure differential is controlled by adjusting the gas pressure.

The apparatus further comprises a heating basket 130 downstream from the inlet port 110, which is configured to receive a charge of the material to be deposited. Between the heating basket 130 and outlet port 120 and along axis A-A are disposed a nozzle 140, a shutter 150, and a substrate 160.

The heating basket 130 is of any type known in the art, for example, a resistively heated tungsten wire basket. The nozzle 140 is configured to accelerate the gas forced through by the pressure gradient, and consequently, to accelerate entrained particles to close to the speed of sound. The shutter 150 has an open position and a closed position. In the open position, the gas stream and entrained particles impinge on the substrate 160. The shutter is of any type known in the art, for example, a gate valve. Then shutter 150 is typically in the open position throughout the disclosed nanocrystal synthesis and deposition process. The substrate 160 is any substrate onto which the deposition of the nanocrystalline silicon is desired, and is discussed in greater detail below.

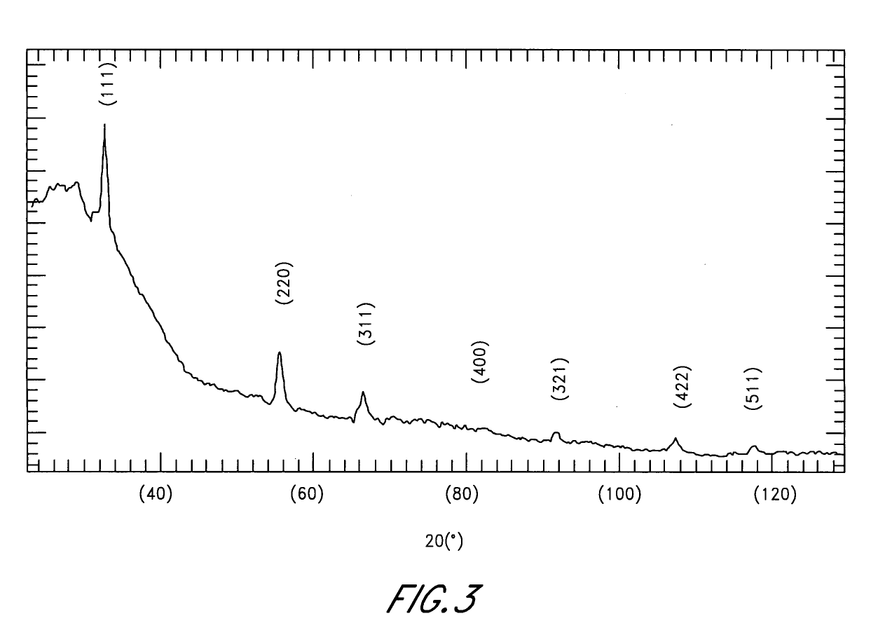

A method 200 for synthesizing silicon nanocrystals using the apparatus 100 is illustrated in FIG. 2. In step 210, a silicon charge in the heating basket 130 is heated, evaporating the silicon into a gas in the deposition chamber 100. A gas stream is generated by introducing the gas through inlet port 110 into the evacuated deposition chamber 100. The deposition chamber 100 is typically evacuated through the outlet port 120 using the attached vacuum source. The rate and pressure of the gas are adjusted to provide a gas stream with a predetermined pressure differential between the inlet port 110 and outlet port 120. The silicon atoms are cooled rapidly within the gas stream. Nanocrystal nuclei are formed in collisions between the cooled atoms. The nanocrystal nuclei move by Brownian motion in the gas stream, forming loose agglomerates. In step 220, the gas stream is accelerated in the nozzle 140 thereby accelerating the entrained nanocrystals to close to the speed of sound. In step 230, the nanocrystals are deposited on the substrate 160. As the particles impact the substrate at high speed, they form a thin film of ballistically consolidated nanocrystals.

In one embodiment, the gas is a “forming gas” comprising hydrogen (H₂). The forming gas may further comprise an inert gas, for example, nitrogen, helium, argon, or neon. In certain embodiments, the forming gas comprises up to about 20% hydrogen, from about 5% to about 15% hydrogen, or about 10% hydrogen, with all gas percentages by volume. In one embodiment, the remainder of the forming gas is an inert gas, preferably nitrogen. It is believed that the hydrogen in the forming gas reduces the formation of silicon oxide on the silicon nanocrystals.

In general, the size of the nanoparticle increases with increasing pressure in the high pressure region. In certain embodiments, the pressure is from about ½ torr to about 5 torr, from about 1 torr to about 4 torr, or from about 2 torr to about 3 torr. In a preferred embodiment, the pressure differential is about 2 torr.

In one embodiment, the silicon in the heating basket 130 is elemental silicon. In embodiments in which the silicon nanoparticles are doped, the heating basket is charged with doped silicon, or charged with a mixture of silicon and the dopant. The temperature of the heating basket 130 is adjusted to provide an acceptable evaporation rate of the silicon. In certain embodiments the temperature is greater than about 1500° C., about 1600° C., about 1700° C., about 1800° C., about 1900° C., or about 2000° C. In the illustrated apparatus, a temperature of about 1800° C. provides an evaporation rate for elemental silicon of about 10⁻³ g/cm²/s.

In another embodiment, the nanostructured silicon is a film, also referred to herein as a “nanofilm.” In certain embodiments, the thickness of the film is not greater than about 300 nm, 290 nm, 280 nm, 270 nm, 260 nm, 250 nm, 240 nm, 230 nm, 220 nm, 210 nm, 200 nm, 190 nm, 180 nm, 170 nm, 160 nm, 150 nm, 140 nm, 130 nm, 120 nm, 110 nm, 100 nm, 90 nm, 80 nm, 70 nm, 60 nm, 50 nm, 40 nm, 30 nm, 20 nm, 10 nm, 5 nm, 2 nm, or 1 nm. In certain embodiments, the nanofilm is not greater than about 200 nm, not greater than about 100 nm, or not greater than about 50 nm. Silicon nanofilms may be synthesized by any means known in the art, for example, by physical vapor deposition or by chemical vapor deposition. In one embodiment, the silicon nanofilm is amorphous. In another embodiment, the silicon nanofilm is crystalline. In still another embodiment, the silicon nanofilm comprises both crystalline and amorphous domains.

Embodiments of the disclosed nanostructured silicon electrodes exhibit large reversible electrochemical capacities. High capacities are expected from the phase diagram of the Li—Si system, but the cycle life and fast diffusion kinetics are not observed in bulk silicon and are believed to arise from the nanostructured nature of the material. Embodiments of the disclosed nanostructured silicon electrodes demonstrate reversible capacities of at least about 2500 mAh/g, 2000 mAh/g, 1500 mAh/g, 1000 mAh/g, 900 mAh/g, 800 mAh/g, 700 mAh/g, 600 mAh/g, or 500 mAh/g, corresponding to theoretical LiₓSi stoichiometries in which x is at least about 2.6, 2.1, 1.6, 1.05, 0.94, 0.84, 0.73, 0.63, or 0.52. Cycle lives are stable over at least about 5, 10, 20, 30, 40, or 50 cycles. In certain embodiments, the coulombic efficiency is at least about 90%, 92%, 94%, 96%, or 98%. Embodiments of the disclosed nanostructured silicon electrodes exhibit rate capabilities of at least about 10C, 20C, 50C, 100C, 200C, 300C, 400C, or 500C, while retaining useful capacities. For example, at 100C, certain embodiments of the nanostructured silicon electrodes exhibit gravimetric capacities of at least about ⅔ of the stable capacity at C/4. In other embodiments, the capacities are at least about ½ of the stable capacity at C/4 at 200C, or at least about ⅓ of the stable capacity at C/4 at 500C. These high rate capacities permit the disclosed nanostructured silicon materials to be used in applications such as electrochemical supercapacitors.

A suitable substrate for the disclosed nanostructured silicon is any suitable material compatible with the conditions for the particular application. In one embodiment, the nanostructured silicon adheres to the substrate, thereby providing physical support to the electrode. In another embodiment, a binder or adhesive is disposed between the nanostructured silicon electrode and the substrate. Suitable binders are discussed in greater detail below. The substrate may have any suitable geometry. In one embodiment, the substrate is planar, for example, a foil or film. In certain embodiments, the substrate has a large surface area, for example, a woven or non-woven fabric. In still another embodiment, the substrate has another shape, for example, corrugations, slits, or the like. In other embodiments, the substrate is not monolithic, for example, comprising particles, beads, rods, fibers, wafers, plates, and the like, which are macro or nanoscale. In certain embodiments, the substrate is flexible. In other embodiments, the substrate is rigid.

In certain embodiments, the substrate also serves as a current collector. In these embodiments, the substrate comprises an electrical conductor. In one embodiment, the substrate/current collector is made from a metal, for example, titanium, iron, stainless steel, nickel, platinum, copper, and gold. In another embodiment, the substrate/current collector is made from a conductive non-metal, for example, graphite, conductive carbon nanotubes, doped diamond, or a doped semiconductor. In still other embodiments, the substrate is a current collector comprising both electrically conductive and electrically non-conductive regions. For example, an electrically conductive material may be formed or deposited on a non-conductive material. In other embodiments, the substrate does not serve as a current collector. In some embodiments, the current collector is applied to the nanostructured silicon electrode after deposition of the electrode on the substrate.

The capacity fade in certain embodiments of the ballistically deposited silicon clusters is believed to stem from decohesion and poor conductivity between aggregates and the current collector. Consequently, certain embodiments of the disclosed nanostructured silicon electrodes comprise a composite of the nanostructured silicon and a binder and/or a conductive diluent (also referred to herein as a “binder/diluent”), which maintains coherence between the nanostructured silicon and/or the current collector. Suitable binders are well known in the art and include poly(vinylidenefluoride) (PVDF), polytetrafluoroethylene (PTFE), styrene-butadiene rubber (SBR), and polyacrylates. Suitable conductive diluents include carbon black, graphite, carbon nanotubes, fullerenes, doped diamond, doped semiconductors, metal particles, or metal films. In one embodiment, the binder/diluent is a material that does not alloy lithium, for example, copper or silver. In another embodiment, the binder/diluent alloys or otherwise binds lithium, for example, graphite.

In one embodiment, a composite electrode comprises nanostructured silicon, for example, silicon nanocrystals, in admixture with a binder/diluent. In other embodiments, the composite electrode comprises layers, strips, islands, or some other pattern of the nanostructured silicon embedded within a binder/diluent. In one embodiment, the composite electrode comprises alternating layers of nanostructured silicon and a binder/diluent, for example, a composite electrode comprising a predetermined number of layers of silicon nanofilms interleaved with copper nanofilms.

In another embodiment, the electrode does not contain a binder and/or a conductive diluent, for example, carbon black or graphite. The addition of a binder or conductive diluent reduces the specific capacity of the electrode.

In certain embodiments, the nanostructured silicon material or lithium-silicon alloy further comprises a silicon oxide (SiO₂) outer layer that may partially or completely cover the surface of the silicon. In certain embodiments, nanostructured silicon material comprises up to about 70% or up to about 50% SiO₂ by weight. Amorphous SiO₂ is also referred to herein as a-SiO₂. As discussed in greater detail below, in some embodiments, the nanostructured silicon material further comprises an alkali metal oxide (M₂O), which in a lithium-ion secondary cell is Li₂O.

In the following Examples, the nanostructured materials were deposited on metallic current collectors, without binders or conductive diluents. Discussions concerning the mechanistic origins of the properties of the disclosed electrodes are provided in certain parts of the disclosure. These discussions and speculations are not limiting on the scope of the disclosure.

Electrochemical tests were performed using a metallic lithium anode in a stainless steel 2016 coin cell. Between about 45 μg and 210 μg of the silicon electrode was used in the test cells. The mass of silicon was determined using TEM and a Mettler micro-balance sensitive to 1 μg. A 0.50 mm thick fiberglass separator was used to isolate the silicon cathode from the lithium anode. A mixture of ethylene carbonate and dimethyl carbonate (EC-DMC) with LiPF₆ (Mitsubishi Chemical Co.) was used as an electrolyte. The test cells were assembled in an argon atmosphere and cycled using an Arbin Instruments BT2000 battery cycler. X-ray diffraction was performed with an INEL CPS-120 diffractometer using Co Kα radiation. The samples for XRD were prepared by a deposition directly onto a glass slide. Scanning electron microscopy (SEM) was performed using a Hitachi S-4100 at 30 kV. SEM samples of cycled electrodes were rinsed in acetone to remove any residual electrolyte from the surface. The uncycled electrodes were studied as deposited.

Transmission electron microscopy (TEM) was performed using a Philips EM 420 at 100 kV and high-resolution electron microscopy (HREM) in a Philips EM 430 at 200 and 300 kV. The TEM samples of the as-deposited materials were prepared by depositing directly onto a holey carbon grid, while the samples from the cycled electrode were prepared by brushing off particles in acetone and floating the detached particles onto a holey carbon grid. All of the lithiated samples (SEM and TEM) were prepared and transported in an argon atmosphere with less than 30 seconds of air exposure.

Electron energy-loss spectroscopy (EELS) was performed with a Gatan 666 parallel detection spectrometer on a Philips EM 420 transmission electron microscope operated at 100 kV. The spectra were acquired at a dispersion of 0.2 eV/channel for the lithiated samples and 0.5 eV/channel for the as-deposited samples, with energy resolutions of 1.2 eV and 1.5 eV, respectively. The full energy-loss spectra were deconvolved using the Fourier-log method.

### EXAMPLE 1

### Physical Vapor Deposition of Silicon Thin Films

Nanostructured silicon films were prepared by evaporation and physical vapor deposition. A charge of elemental silicon was evaporated under a vacuum of 6×10⁻⁶ torr in a tungsten wire heating basket. A nickel/copper substrate was placed directly below the tungsten basket, and the evaporated silicon atoms were deposited onto the substrates in a continuous thin film approximately 100 nm thick.

### EXAMPLE 2

### Inert Gas Condensation and Ballistic Consolidation of Silicon Nanoparticles

Nanocrystalline silicon clusters were prepared by inert gas condensation and ballistic consolidation in the apparatus illustrated in FIG. 1. The gas stream was a forming gas composed of 90% N₂ and 10% H₂ with a pressure differential of 2 torr. An elemental silicon charge was heated to about 1800° C. in a tungsten wire basket, providing an evaporation rate of up to 10⁻³ g/cm²/s.

A variety of substrates was used in the depositions. Metal-coated fiberglass substrates were prepared by evaporating a thin layer of metal (nickel or copper) onto a nonwoven fiberglass (Crane & Co., Inc.) consisting of a web of uniformly distributed fibers, approximately 8 μm in diameter. These substrates provided high-surface-area conductive substrates for electrochemical cells. The nanocrystalline silicon particles were deposited onto the metal-coated fiberglass substrates. Other electrodes were deposited on nickel-copper-coated planar substrates prepared as follows. First, the surface of a 2016 stainless steel coin cell was roughened using 400 grit sandpaper. Next, a thin nickel/copper coating (about 100 nm) was then evaporated on the surface and finally, the silicon nanocrystals were deposited onto the nickel/copper-coated planar substrate.

### EXAMPLE 3

### Characterization of Ballistically Deposited Silicon Nanoparticles

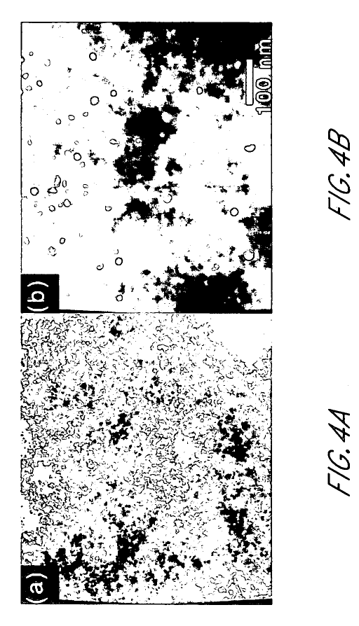

The ballistically deposited samples were found to be predominately crystalline. Silicon nanoparticles were ballistically deposited on a glass substrate according to EXAMPLE 1. The XRD pattern of the silicon nanoparticles provided in FIG. 3 shows sharp peaks corresponding to the diamond cubic positions of crystalline silicon. The large broad peak at about 30° is probably predominately the glass substrate, but may also mask contributions from an amorphous component, for example, amorphous silicon oxide that forms readily on the surface of silicon.

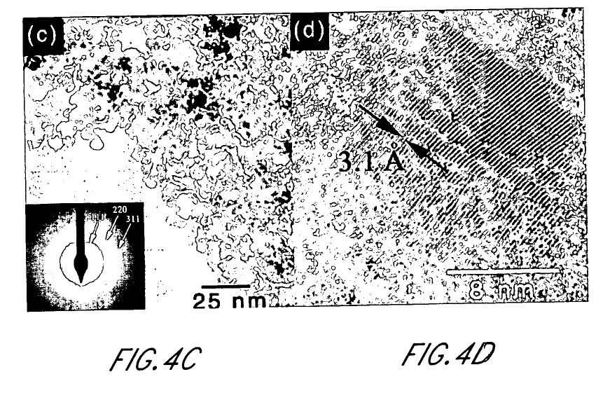

A more direct analysis of the microstructure of the ballistically deposited sample was performed by TEM. FIG. 4a and FIG. 4b provide a bright-field/dark-field image pair of the as-deposited silicon nanoparticles, respectively. FIG. 4c is another bright-field TEM image with the associated electron diffraction pattern inset. Note the interconnected nanocrystals. In the ballistically deposited electrode, the silicon nanocrystals appear to form a web of interconnected particles. These images illustrate the small crystallites (5-20 nm in diameter) and low density of the material. The bright spots in the dark-field image FIG. 4b correspond to small diamond cubic crystals of silicon having similar crystallographic orientations.

FIG. 4d is a HREM image illustrating the complexity of the microstructure with the presence of crystallite and amorphous regions. The lattice fringes from the small crystallite in the center originate with silicon (111) planes separated by 3.1 Å. The region surrounding the crystallite appears to be an amorphous shell approximately 25 Å in thickness.

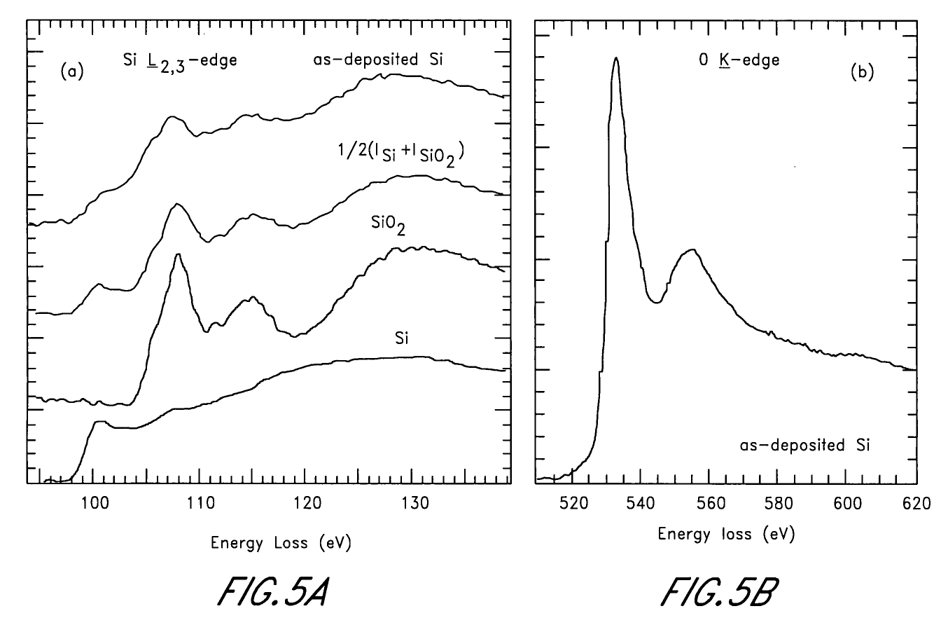

To quantify the concentration of oxide on the ballistically deposited silicon nanocrystals, EELS was performed on various regions of the sample. FIG. 5a provides the silicon L_{2,3}-edges of from bottom to top, a standard silicon sample, a standard SiO₂ sample, an average of the silicon and SiO₂ spectra [½(I_{Si}+I_{SiO}_{₂})], and a ballistically deposited sample. Qualitative analysis of these spectra suggests that the ballistically deposited sample consists of crystalline silicon and a-SiO₂ because the average of the standard silicon and SiO₂ spectra closely resembles the spectrum of the as-deposited material. The oxygen K-edge of the silicon nanocrystals is provided in FIG. 5b, which further confirms the presence of oxygen. The shape of the O K-edge is characteristic of SiO₂, suggesting that the oxygen contribution is not from a suboxide, such as SiO.

An elemental analysis was performed using the silicon L_{2,3} and oxygen K-edges. The integrated intensity of the inner-shell edge was used to determine the atomic ratio of silicon to oxygen, N_{Si}/N_{O}. Using the thin-film approximation, the atomic ratio (N_{Si}/N_{O}) for three different regions were measured to be 0.8-1.0 suggesting that the ballistically consolidated silicon nanoparticles contain between 50-67% SiO₂. The thin-film approximation provides the ratio of two elements α and β:

$$\frac{{N}_{α}}{{N}_{β}} \approx \frac{{I}_{α k}}{{I}_{β {k}^{′}}} \frac{{σ}_{α {k}^{′}}}{{σ}_{β k}}$$

where I is the integrated edge intensity, σ is the reduced cross section, and k and k′ indicate the particular edge used (k, k′=K, L, M, N, . . . ).

A similar analysis of an evaporated silicon thin film prepared according to EXAMPLE 1 indicated that the nanofilm contained less oxygen.

### EXAMPLE 4

### Sample Characterization of Silicon Thin Films

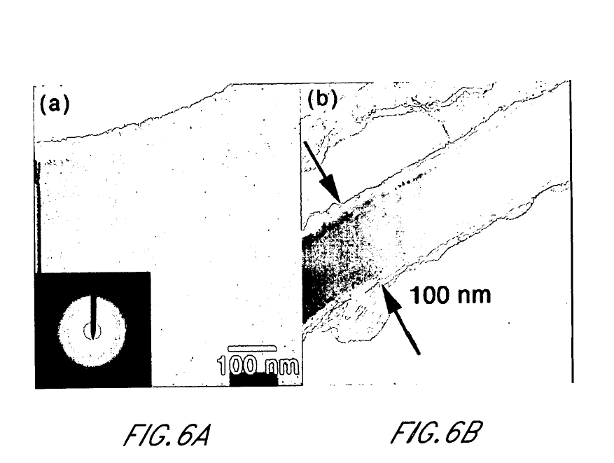

X-ray diffractometry and TEM were used to characterize the structure of the evaporated silicon thin film prepared in EXAMPLE 1. FIGS. 6a and b provide TEM bright-field images of the evaporated silicon in the planar and cross-sectional views, respectively. The TEM cross section indicates a film thickness of about 100 nm. The absence of sharp peaks in the electron diffraction pattern (inset of FIG. 6a) demonstrates that the material is substantially amorphous. The absence of long range order was confirmed by XRD. The lack of structure in these images indicates that the silicon is deposited as a contiguous film, unbroken by grain boundaries, dislocations, or cracks.

### EXAMPLE 5

### Electrochemical Results for Ballistically Deposited Silicon Nanoparticles

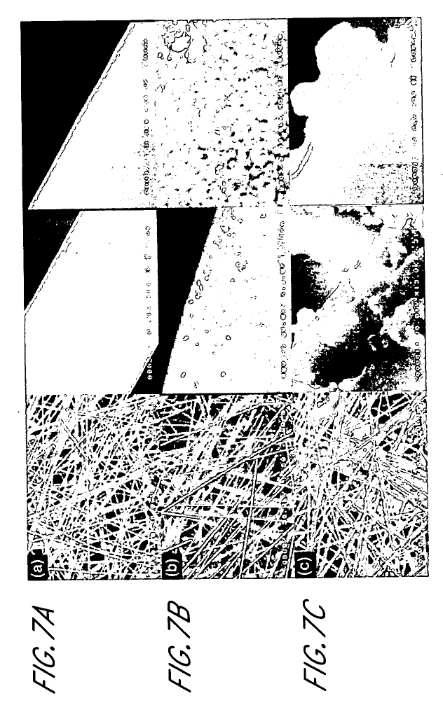

The nanocrystalline silicon clusters were prepared by deposition onto a nickel-coated fiberglass as described in EXAMPLE 1. FIG. 7 provides SEM images of the nickel-coated fibers before (FIG. 7a) and after (FIG. 7b) the silicon deposition, and after the first complete electrochemical alloying with lithium (discharge) (FIG. 7c). The nickel-coated fibers in FIG. 7a have a smooth metallic surface and are approximately 8 μm in diameter. FIG. 7b illustrates a conformal deposition of the silicon particles onto the metal-coated fibers. The nanoparticles are assembled into small islands of secondary particles (aggregates) approximately 100 nm in diameter. The smooth irregular surface of FIG. 7c suggests the formation of a passivation layer upon lithiation.

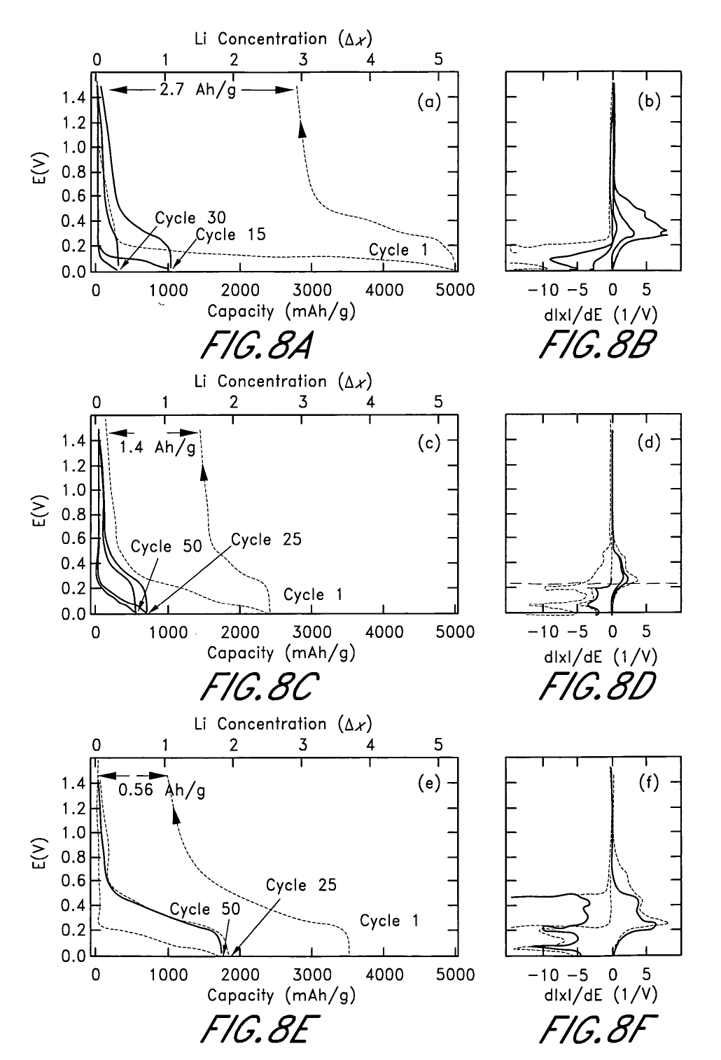

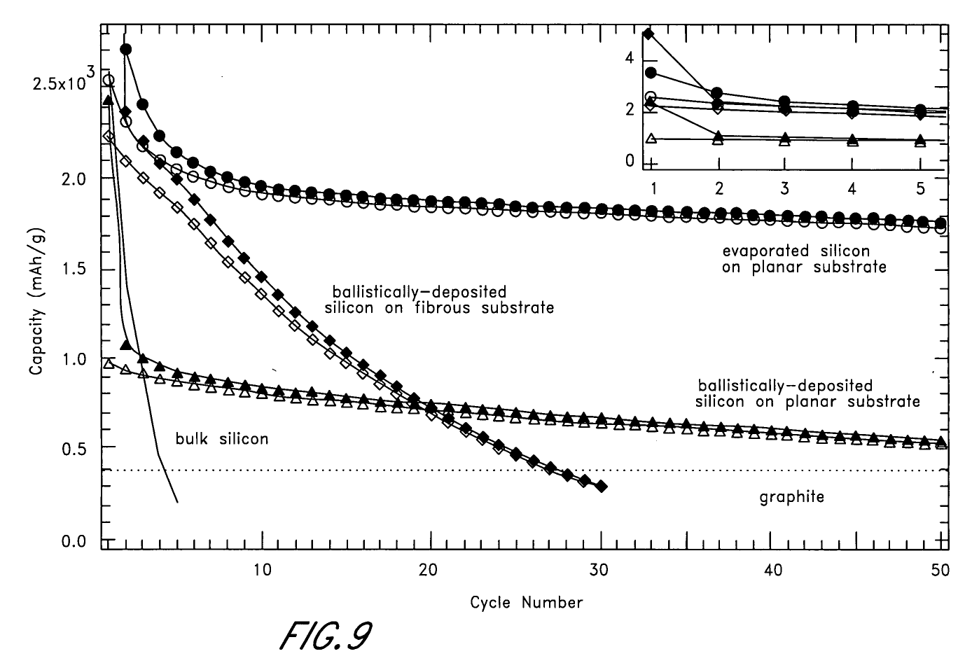

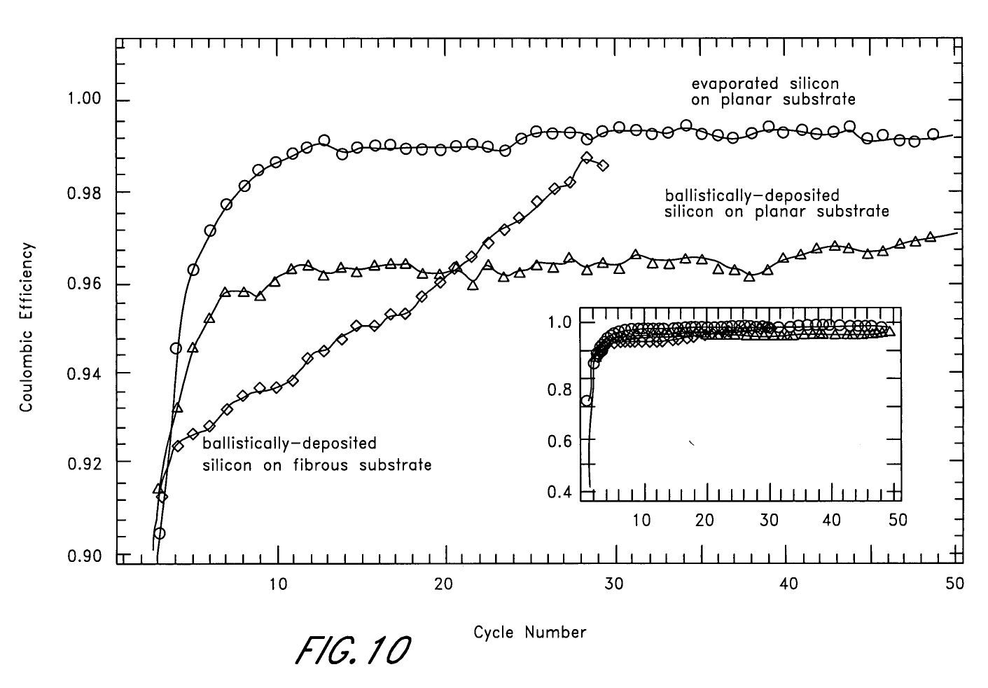

A plot of the voltage profile for cycles 1, 15, and 30 of the nanocrystalline silicon on a nickel-coated fibrous substrate is provided in FIG. 8a. FIG. 8b is a plot of the differential capacity, d|x|/dE, where |x| is the absolute value of the lithium concentration and E is the cell potential. A large irreversible capacity is evident on the first cycle, which exhibits a discharge capacity (Q_{d}) of 5100 mAh/g and a charge capacity (Q_{c}) of 2250 mAh/g. This disparity yields a low coulombic efficiency (Q_{c}/Q_{d}) of 44%. The second cycle demonstrates a reversible capacity of 2100 mAh/g. A plot of the cycle life of the nanocrystalline silicon electrode prepared on a fibrous substrate is provided in FIG. 9. The coulombic efficiency increased steadily during the electrochemical cycling reaching 98% by cycle 30 (FIG. 10). These results suggest that in the early stages of cycling more lithium is inserted into the host than removed. The low coulombic efficiency likely arises from a high cell impedance. The increase in the cell efficiency is accompanied by a significant decrease in specific capacity.

Additional electrodes of nanocrystalline silicon clusters were prepared by ballistic consolidation on a rough, planar substrate as described in EXAMPLE 1. The voltage profiles from electrochemical cycles 1, 25, and 50 are displayed in FIG. 8c. The differential capacity for these cycles is shown in FIG. 8d. This electrode exhibited an initial discharge capacity of 2400 mAh/g during the first insertion of lithium, and a subsequent charge capacity of 1000 mAh/g, giving a coulombic efficiency of 41% for the first cycle. This high irreversible capacity was limited to the first cycle, however. Cycles 2-50 demonstrate a stable specific capacity of approximately 1000 mAh/g (FIG. 9). The capacity fade correlates inversely with the coulombic efficiency, which was found to increase steadily up to 96% by cycle number 9 (FIG. 10). In this reversible region, the nanocrystalline electrode exhibited a mean capacity loss of approximately 20 mAh/g per cycle with a final capacity of 525 mAh/g on cycle number 50.

### EXAMPLE 6

### Electrochemical Results for Silicon Thin Films

The thin amorphous silicon films synthesized according to EXAMPLE 2 displayed excellent electrochemical properties. The voltage profiles obtained from cycles 1, 25, and 50 are provided in FIG. 8e. The differential capacity is provided in FIG. 8f The initial discharge capacity of about 3500 mAh/g suggests that up to 3.6 lithium atoms per silicon atom are involved in the initial alloying. The following charge capacity of 2500 mAh/g (2.6 lithium atoms per silicon atom) yields a coulombic efficiency of 71% on the first cycle. Upon subsequent cycling, the electrode exhibited a rather stable specific capacity about 2000 mAh/g (FIG. 9). The capacity stabilization corresponds to an increase in the coulombic efficiency to 98% on cycle number 9 (FIG. 10). After 20 cycles, the amorphous thin film exhibited a mean capacity loss of only 8 mAh/g per cycle.

### EXAMPLE 7

### Kinetics of Silicon Thin Films

The kinetics of lithium diffusion in the silicon nanofilms prepared according to EXAMPLE 1 were investigated using variable rate electrochemical cycling. The charge/discharge rate is expressed in terms of half-cycles per hour. In this notation, a rate of C/4 denotes the current density required to completely charge or discharge the cell in 4 hours. Accordingly, a rate of 100C indicates a full charge in 36 seconds. The rate is normalized to correspond to the time required to lithiate the material to the empirical maximum capacity, C₀:

$$C Rate = \frac{1}{t} \frac{C}{{C}_{0}}$$

where t is the time (hours) required to reach the maximum voltage and C is the measured capacity.

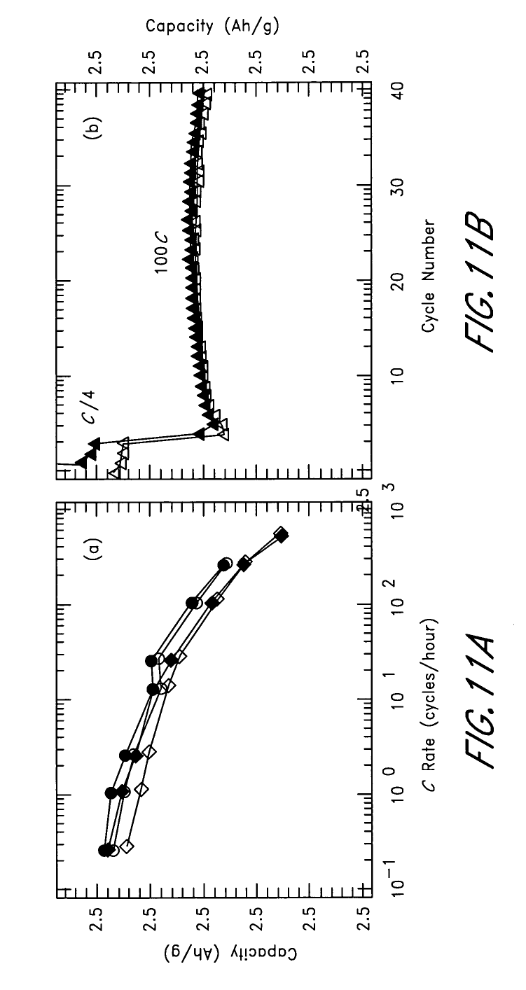

A 40-nm thick evaporated film was cycled four times at a rate of about C/4 (8 hour full cycle) to establish a stable capacity. The rate of subsequent cycles was increased up to approximately 200C on the initial series. The rate was then reduced back to C/4 and the process was repeated to a rate of up to about 500C. FIG. 11a provides a plot of the dependence of the gravimetric capacity on the cycling current. An evaporated silicon thin film of similar thickness (about 40 nm) was cycled at a rate of approximately 100C to determine the lifetime of the electrode when cycled at a high rate (FIG. 11b). The capacity was stable to about 1600 mAh/g for a lifetime of 40 cycles.

Extremely fast kinetics are observed in FIG. 11a in which the evaporated thin film was cycled at rates spanning three order of magnitude. These results indicate that the silicon film can be completely discharged in only a few seconds while maintaining close to half the empirical capacity (about 1100 mAh/g). This process can by equivalently described as the rapid alloying (about 200C) of lithium with silicon up to a stoichiometry of Li_{1.2}Si. The rapid lithium kinetics are believed possible because of the short diffusion lengths involved in the alloying process. Because the time scales for diffusion are proportional to the square of the diffusion length, the disclosed nanostructured particles and films accommodate high cycling rates.

In a typical electrode, the rapid insertion of lithium drastically reduces the gravimetric capacity and can lead to microstructural damage, as discussed above. Assuming a constant diffusivity, the strain gradients increase with the rate of lithium insertion. The increase of the strain energy raises the driving force for nucleating dislocations and cracks. An interesting feature illustrated in FIG. 11a is that there is no irreversible capacity associated with increasing the cycling rate by three orders of magnitude. The capacity at a C/4 rate is equivalent before and after the high-rate cycling, indicating that high current densities in the silicon nanofilm do not decrepitate the host. FIG. 11b indicates that even at the high rate of 100C, the electrode retains 67% of its original capacity. Remarkably, the fast cycling does not appear to degrade the overall cycle life of the electrode.

### EXAMPLE 8

### Sample Characterization of Lithiated Silicon Nanocrystals

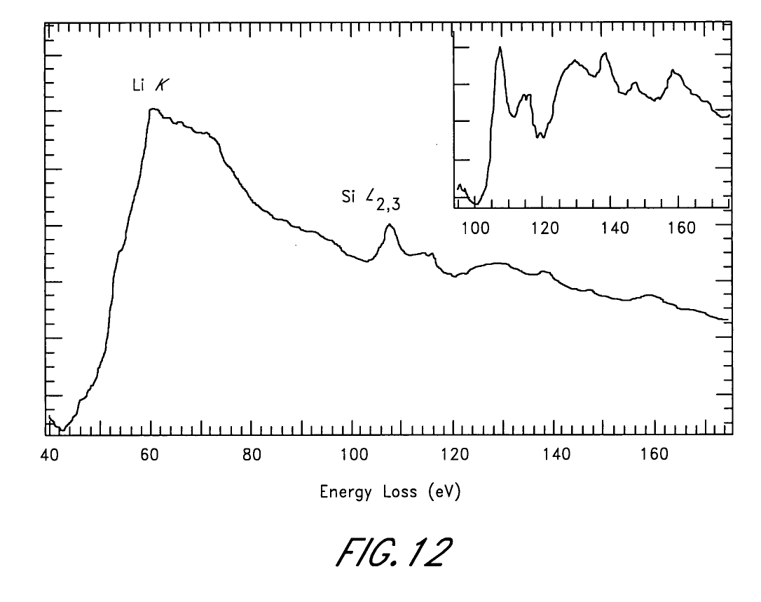

An elemental analysis of the fully lithiated, ballistically consolidated silicon prepared according to EXAMPLE 5 was performed using quantitative EELS. The energy-loss spectrum in FIG. 12 shows a strong lithium K-edge at about 54 eV. The edge intensity was determined using a 20 eV integration window about the lithium K-edge (55-75 eV) and silicon L_{2,3}-edge (99-119 eV). An atomic ratio was calculated using the ratio of the edge intensities weighted by the hydrogenic cross sections in the thin film approximation. The quantitative EELS analysis revealed an atomic ratio N_{Li}/N_{Si} as large as 4.3 after the first discharge. This suggests that the lithiated stoichiometry is close to Li₂₂Si₅, and suggests that the lithium is not simply plated onto the surface but is actually inserted into the silicon host.

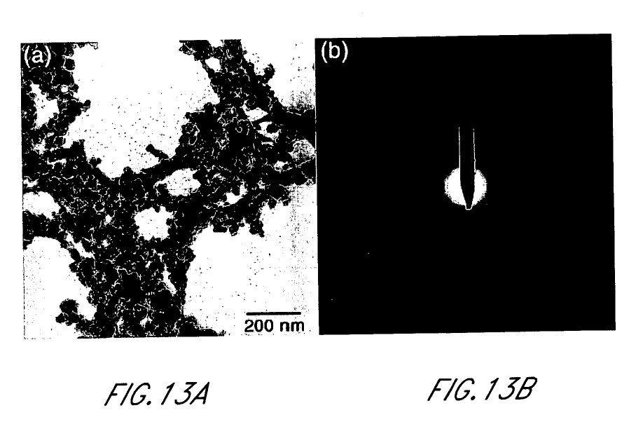

A TEM bright-field image and an electron diffraction pattern of the fully lithiated, ballistically deposited silicon are displayed in FIGS. 13a and b, respectively. The broad diffuse rings of the electron diffraction pattern of Li—Si (FIG. 13b) indicate that the nanocrystalline silicon is amorphous in the lithiated state. These results suggest that the nanocrystalline silicon transforms into a metastable glassy phase at room temperature through a mechanism known as electrochemically driven solid-state amorphization.

This transformation is also consistent with the voltage profiles of FIGS. 8a-f. The charge and discharge curves do not exhibit multiple flat plateaus, which would be expected if the material passed through different crystallographic phases. Although the voltage profiles vary slowly and continuously during cycling, there appear to be reproducible slope changes in the potential. These changes are manifested as peaks in FIGS. 8b, d, and f, which plot the differential capacity (d|x|/dE) vs. cell potential. The 500 mV peak, which is only observed on the first few cycles, is consistent with a reaction of lithium at the interface of the electrode and electrolyte. The two primary peaks at 100 mV and 200 mV are relatively unchanged with cycling and suggest that some local preferential ordering does occur during lithiation. However, the smooth voltage profiles and diffuse electron diffraction pattern suggest that the long-range order is absent in the lithiated phase.

Irreversible Capacity

The lower coulombic efficiencies exhibited in the first cycles may be attributed in part to the formation of a solid-electrolyte interphase (SEI). This passivation layer is expected to form through a reaction of the lithium with the solvent (EC DMC) and the salts (LiPF₆) of the electrolyte. SEM images of the ballistically deposited silicon clusters after the first discharge (FIG. 7c) reveal smooth electrode surfaces, in contrast with the fine-scale roughness of the as-deposited material. Although the change in the surface appearance could be partially attributed to the volume expansion during lithiation, there appears to be a contiguous passivation layer, which also emerges after the first lithium insertion. The formation of an SEI is also supported by the 500 mV peaks in the differential capacity plots of FIGS. 8b, d, and f, which disappear after a few cycles. The formation of an SEI may lead to an irreversible capacity through two mechanisms: (1) the loss of lithium to the formation of the SEI, and (2) an increase in the cell impedance. Since the sharp capacity fade is limited to the first few cycles, it is believed that the reactions contributing to the SEI layer occur during the initial cycles.

It is thermodynamically favorable for lithium to reduce SiO₂ (the native oxide on silicon) through the displacement reaction:

4Li+SiO₂→2Li₂O+Si.

The formation of Li₂O is driven by the differences in the free energies of formation between a-SiO₂ (ΔG°_{f}=−849.8 kJ/mol) and 2Li₂O (ΔG°_{f}=−1121.0 kJ/mol). The free energy difference is equivalent to 704 mV. The formation of Li₂O from a convertible oxide is well documented in the SnO system, which has approximately twice the thermodynamic driving force of 1.58 V. This irreversible reaction occurs in the early stages of the first discharge, and is followed by the alloying of the remaining lithium with elemental silicon. In the subsequent cycles, the lithium is reversibly alloyed with silicon while the Li₂O remains inactive. The large irreversible capacity on the first cycle is considerably reduced in the cycling characteristics of the thin film electrode due to the low mass of the surface oxide relative to the bulk film. It is likely that the large quantity of SiO₂ in the high-surface area nanocrystals is partially responsible for the reduced capacity observed in this material.

Adhesion

After about cycle number 20, capacity fade may arise from a different mechanism. In the ballistically deposited silicon, it is believed to originate from the spallation of silicon from the electrode and metal current collector because silicon nanoparticles were found in the cell after extensive cycling. The absence of binder, coupled with a large volume change, are likely causes for the spalling of the silicon aggregates off the current collector. This later-stage capacity fade depended on the type and preparation of the substrate surface. The capacity fade was greatest for the nickel fibers, suggesting that the silicon aggregates are less prone to spalling off the planar substrate.

Cycle Life

Compared to bulk silicon, which has essentially no cycle life, both types of nanostructured silicon demonstrate superior far charge/discharge cycling performances. We believe that the improved cycle life to the absence of conventional mechanisms for microstructural damage. Dislocations have never been reported in crystals of the disclosed dimensions (<20 nm), probably because any such dislocations are quickly drawn to the surface by image forces. For brittle materials such as silicon, decrepitation occurs through the formation of cracks and their propagation by dislocation emission from the crack tip. For a crack to propagate, however, it must exceed a critical size, a_{c}:

$${a}_{c} = \frac{2}{π} \frac{{K}_{1 c}^{2}}{{σ}^{2}} .$$

The fracture toughness, K_{1c}, and yield strength, σ, in polycrystalline silicon are approximately 0.751 MPa/m^{1/2} and 1.1 GPa, respectively. These values yield a critical flaw size of about 300 nm, which is similar to or larger than the dimensions of the disclosed nanostructured electrode materials. Although this calculation is for pure silicon, the critical flaw size of lithiated silicon is not expected to be comparable to the dimensions of the disclosed particles, which are about an order of magnitude smaller in diameter.

Because strain gradients can generate defects in solids, lithium concentration gradients can cause microstructural damage in bulk silicon. An advantage of nanostructured materials is that relaxation times, τ, for diffusion are short, owing to the small dimension, d, since τ=d²/D, where D is the diffusivity. The lithium concentration is expected to be more uniform in nanostructured materials cycled at moderate rates.

The relatively open structure of the ballistically consolidated nanocrystalline silicon material seems capable of accommodating the large volume expansions accompanying lithiation. The robustness of the amorphous silicon nanofilms during electrochemical cycling probably arises from different mechanisms, however. Both types of electrodes appear to be amorphous in the lithiated phase. Although this may suppress stress gradients, one may nevertheless expect the volume expansion might lead to decohesion of the film from the metal substrate. It is plausible that the film is separated from the substrate along much of its interface, making electrical contact at a few points. For example, the film might bow outward from the substrate during lithiation, but remain anchored adequately for electrical continuity.

The embodiments illustrated and described above are provided as examples of certain preferred embodiments of the present invention. Various changes and modifications can be made to the embodiments presented herein by those skilled in the art without departure from the spirit and scope of this invention, the scope of which is limited only by the claims appended hereto.

What is claimed is:

1. An electrode for a secondary electrochemical cell comprising a silicon nanofilm or a lithium alloy thereof.

2. The electrode of claim 1, wherein the silicon nanofilm alloys with lithium at ambient temperature.

3. The electrode of claim 1, wherein the lithium alloy has a theoretical stoichiometry LiₓSi, and x is at least about 2.1.

4. The electrode of claim 1, wherein the silicon nanofilm is not greater than about 200 nm thick.

5. The electrode of claim 4, wherein the silicon nanofilm is not greater than about 100 nm thick.

6. The electrode of claim 1, wherein the silicon nanofilm is substantially amorphous.

7. The electrode of claim 1, wherein the silicon nanofilm is synthesized by physical vapor deposition.

8. A electrode for a secondary electrochemical cell comprising a silicon nanoparticle or a lithium alloy thereof, wherein the diameter of the silicon nanoparticle is not greater than about 50 nm in diameter.

9. The electrode of claim 8, wherein the silicon nanofilm alloys with lithium at ambient temperature.

10. The electrode of claim 8, wherein the lithium alloy has a theoretical stoichiometry LiₓSi, and x is at least about 1.05.

11. The electrode of claim 8, wherein the silicon nanoparticle has a crystalline domain.

12. The electrode of claim 8, wherein the silicon nanoparticle is synthesized by inert gas condensation and ballistic consolidation.

13. An electrode for a secondary electrochemical cell comprising nanostructured silicon or a lithium alloy thereof, wherein the electrode does not comprise carbon black.

14. The electrode of claim 13, wherein the silicon nanofilm alloys with lithium at ambient temperature.

15. The electrode of claim 13, wherein the specific capacity is at least 1000 mAh/g.

16. The electrode of claim 15, wherein the specific capacity is at least 2000 mAh/g.

17. The electrode of claim 13, wherein the cycle life is at least about 20.

18. The electrode of claim 13, wherein the specific capacity at 100C is at least about ⅔ of the specific capacity at C/4.

19. The electrode of claim 13, wherein the nanostructured silicon comprises a silicon nanoparticle.

20. The electrode of claim 13, wherein the nanostructured silicon comprises a silicon nanofilm.

21. A method of synthesizing a silicon nanoparticle comprising evaporating elemental silicon into a gas, thereby forming a silicon nanocrystal, wherein the gas comprises hydrogen.

22. The method of claim 21, wherein the gas further comprises nitrogen.

23. The method of claim 21, wherein the elemental silicon is substantially pure silicon.

24. The method of claim 21, wherein the silicon nanocrystal is entrained in the gas, the method further comprising:
accelerating the gas and entrained nanocrystal; and
depositing the nanocrystal on a substrate.

25. A silicon nanoparticle synthesized by a method comprising evaporating elemental silicon into a gas, thereby forming a silicon nanocrystal, wherein the gas comprises hydrogen.

26. A secondary electrochemical cell comprising an anode, a cathode, and an electrolyte, wherein the anode comprises a silicon nanofilm or a lithium alloy thereof.

27. The secondary electrochemical cell of claim 26, wherein the silicon nanofilm is not greater than about 200 nm thick.

28. The secondary electrochemical cell of claim 26, wherein the secondary electrochemical cell is a battery or an electrochemical supercapacitor.

29. A secondary electrochemical cell comprising an anode, a cathode, and an electrolyte, wherein
the anode comprises a silicon nanoparticle or a lithium alloy thereof, and
the diameter of the silicon nanoparticle is not greater than about 50 nm in diameter.

30. The secondary electrochemical cell of claim 29, wherein the silicon nanoparticle is synthesized by inert gas condensation and ballistic consolidation.

31. The secondary electrochemical cell of claim 29, wherein the secondary electrochemical cell is a battery or an electrochemical supercapacitor.

32. A secondary electrochemical cell comprising an anode, a cathode, and an electrolyte, wherein
the anode comprises nanostructured silicon or a lithium alloy thereof, and
the anode does not comprise dispersed carbon black.

33. The secondary electrochemical cell of claim 32, wherein the nanostructured silicon comprises a silicon nanoparticle.

34. The secondary electrochemical cell of claim 32, wherein the nanostructured silicon comprises a silicon nanofilm.

35. The secondary electrochemical cell of claim 32, wherein the secondary electrochemical cell is a battery or an electrochemical supercapacitor.
